(19) United States
(12) Patent Application Publication
(10) Pub. No.: US 2011/0174347 A1
(43) Pub. Date: Jul. 21, 2011

(54) RESONATOR FOR ULTRASONIC MACHINING AND ULTRASONIC MACHINING EQUIPMENT

(75) Inventors: Shigeru SATO, Fukuoka (JP); Mayumi KOUYA, Fukuoka (JP); Mitsugu KATSUMI, Fukuoka (JP); Ryoichi ISHII, Fukuoka (JP); Takahiro ITO, Fukuoka (JP); Hideyuki OBATA, Fukuoka (JP)

(73) Assignee: ULTEX CORPORATION, Fukuoka-shi (JP)

(21) Appl. No.: 12/688,561

(22) Filed: Jan. 15, 2010

(51) Int. Cl. B08B 3/12

(52) U.S. Cl. 134/56 R; 134/133

(57) ABSTRACT

A resonator is used for ultrasonic machining and attached to the side or bottom of a liquid tank so as to pass through the liquid tank used in ultrasonic machining equipment for dipping a workpiece part in machining liquid given supersonic vibration. The resonator includes a working vessel formed in one end of the resonator within the liquid tank as a dent opening upward so as to enable the workpiece part to be inserted therein from above and part of the machining liquid in the liquid tank to be accommodated therein as separated from the machining liquid in the liquid tank.

### BACKGROUND OF THE INVENTION

1. Field of the Invention

The present invention relates to a resonator for ultrasonic machining and ultrasonic machining equipment each capable of appropriately performing soldering or ultrasonic cleaning.

2. Description of the Prior Art

The soldering device disclosed in JP-A HEI 9-271936 is shown in FIG. 14. In the soldering device of FIG. 14, in a state wherein solder melt 43 is introduced into a solder bath 41 so that the liquid level of the solder melt 43 may be disposed at a position lower than the position of an opening 45 of the solder bath 41, in which a resonator 44 is provided, and wherein a liquid level adjustment body 19 is introduced into the solder melt 43 in the solder bath 41 by means of an elevating/lowering mechanism 20 to adjust the liquid level of the solder melt 43 to be higher than the position of the opening 45, when a stirring mechanism 46, such as a pump, has been driven, the solder melt 43 is introduced from the solder bath into a working vessel 42 and thus circulated in directions shown by arrows Y5 as overflowing from the working vessel 42 and returning to the solder bath 41. In addition, in a state wherein the resonator 44 has afforded supersonic vibration to the solder melt 43 in the working vessel 42, workpiece parts 16 of a workpiece 15 supported on a workpiece handling mechanism 14 are dipped into the solder melt 43 to solder the workpiece parts 16. When interchanging the resonator 44, the liquid level adjustment body 19 is elevated upward by means of the elevating/lowering mechanism 20 to adjust the liquid level of the solder melt 43 to be lower than the position of the opening 45. Since the soldering device has a configuration in which the working vessel 42 surrounds the resonator 44, however, when performing soldering, it is difficult to transmit the supersonic vibration from the resonator 44 to the workpiece parts 16 that have been dipped into the solder melt 43 flowing into the working vessel 42, the wettability of the solder to the workpiece parts 16 is not good, and the workpiece parts 16 are brought to a state in which they are unstably swung by the flow of the solder melt 43. Thus, the soldering device is disadvantageous in that the range of soldering becomes wider than that of the workpiece parts 16. Furthermore, in the soldering device of FIG. 14, though the solder melt 43 can clean the workpiece parts 16 when substituting cleaning liquid for the soldering melt 43, this case has the same disadvantage as the case of the soldering. The elevating/lowering mechanism 20 comprises a fixed base 21, a motor 22, a threaded rod 23, a guide mast 24 and an elevating/lowering member 25. The fixed base 21 is attached to the solder bath 41, the motor 22 to the fixed base 21 and the guide mast 24 also to the fixed base 21. The threaded rod 23 is rotated with the motor 22. The elevating/lowering member 25 is elevated or lowered along the guide mast 24 with the rotation of the threaded rod 23. Denoted by reference numeral 4 is a heater.

The object of the present invention is to make the ultrasonic machining appropriate.

### SUMMARY OF THE INVENTION

To attain the above object, the present invention provides a resonator used for ultrasonic machining and attached to a side or bottom of a liquid tank so as to pass through the liquid tank used in ultrasonic machining equipment for dipping a workpiece part in machining liquid given supersonic vibration, the resonator comprising a working vessel formed in one end of the resonator within the liquid tank as a dent opening upward so as to enable the workpiece part to be inserted therein from above and part of the machining liquid in the liquid tank to be accommodated therein as separated from the machining liquid in the liquid tank. The present invention further provides Ultrasonic machining equipment comprising a liquid tank, a resonator attached to a side or bottom of the liquid tank so as to pass through the liquid tank, a vibrator joined to one end of the resonator outside the liquid tank, a working vessel formed in the other end of the resonator inside the liquid tank as a dent so as to enable a workpiece part to be inserted therein from above and part of machining liquid introduced into the liquid tank to be accommodated therein as separated from the machining liquid, and one of (a) a liquid level adjustment mechanism provided within the liquid tank for adjusting a liquid level introduced into the liquid tank to be higher and lower than an opening of the working vessel, (b) a pipe provided over the liquid tank and working vessel and a supply mechanism provided in the liquid tank for supplying the machining liquid in the liquid tank from the pipe to the working vessel and (c) a tank for storing the machining liquid in the liquid tank so as to adjust the liquid level of the machining liquid in the liquid tank to be lower than the opening of the working vessel, a valve for opening/closing a passage for the machining liquid from the liquid tank to the tank and a pump for returning the machining liquid from the tank to the liquid tank so as to adjust the liquid level of the machining liquid in the liquid tank to be higher than the opening of the working vessel.

Since the working vessel is provided in one end of the resonator in the liquid tank, the resonator for ultrasonic machining according to the present invention has the advantage of enabling part of the machining liquid within the liquid tank to be accommodated within the working vessel as separated from the machining liquid within the liquid tank, supersonic vibration to be well transmitted from the resonator to the workpiece part dipped in the machining liquid standing still within the working vessel, and the workpiece part to be appropriately subjected to soldering or cleaning. Furthermore, since part of the machining liquid is accommodated within the liquid vessel as separated from the machining liquid within the liquid tank and supersonic vibration is well transmitted from the resonator to the workpiece part dipped in the machining liquid standing still within the working vessel using the adjustment mechanism, supply mechanism or mechanism provided with the tank, valve and pump, the ultrasonic machining equipment of the present invention has the advantage of enabling the workpiece part to be appropriately soldered or cleaned.

The above and other objects, characteristic features and advantages of the present invention will become apparent from the description to be given herein below with reference to the accompanying drawings.

### BRIEF DESCRIPTION OF THE DRAWING

FIG. 1 is a cross section showing ultrasonic machining equipment according to one embodiment of the present invention.

FIG. 2 is a perspective view showing a resonator according to the embodiment.

FIG. 3 includes explanatory views showing steps of machining according to the embodiment.

FIG. 4 is a cross section showing ultrasonic machining equipment according to the second embodiment of the present invention.

FIG. 5(a) is a perspective view showing an example of a resonator according to the second embodiment, and FIG. 5(b) is a perspective view showing another example of the resonator according to the second embodiment.

FIG. 6 is a cross section showing ultrasonic machining equipment according to the third embodiment of the present invention.

FIG. 7 includes explanatory views showing the steps of machining according the third embodiment.

FIG. 8 is a cross section showing ultrasonic machining equipment according to the fourth embodiment of the present invention.

FIG. 9 includes explanatory views showing the steps of machining according the fourth embodiment.

FIG. 10 is a cross section showing ultrasonic machining equipment according to the fifth embodiment of the present invention.

FIG. 11 includes explanatory views showing the steps of machining according the fifth embodiment.

FIG. 12 is a cross section showing ultrasonic machining equipment according to the sixth embodiment of the present invention.

FIG. 13 is a cross section showing ultrasonic machining equipment according to the seventh embodiment of the present invention.

FIG. 14 is a cross section showing a conventional soldering device.

### DETAILED DESCRIPTION OF THE PREFERRED EMBODIMENTS

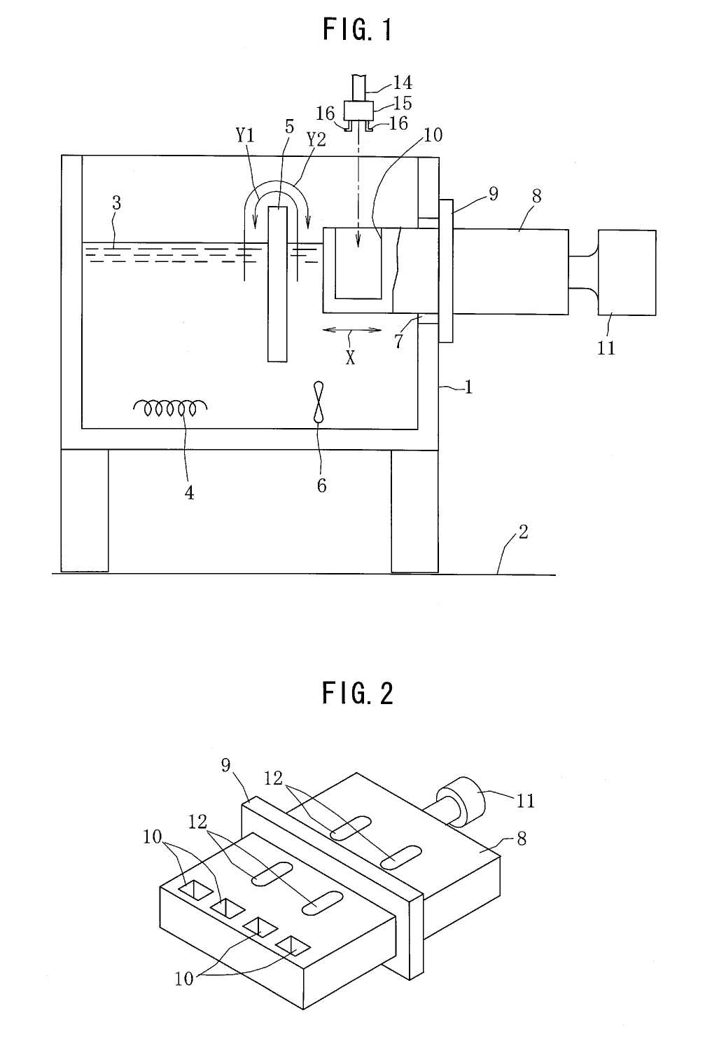

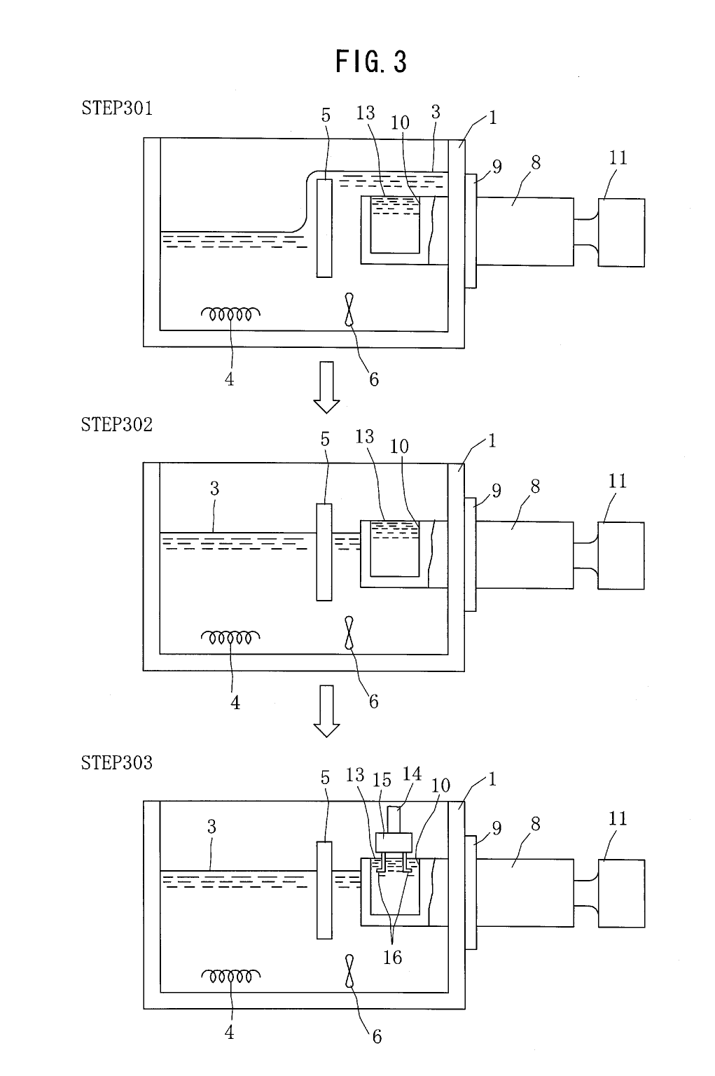

FIG. 1 shows a longitudinal cross section of ultrasonic machining equipment, FIG. 2 a resonator 8, and FIG. 3 steps of machining.

The structure of the ultrasonic machining equipment will be described with reference to FIG. 1. A liquid tank 1 of the ultrasonic machining equipment is mounted on a mounting surface 2, such as the floor of a factory, and formed like a bath having an upper opening. Machining liquid 3, such as solder melt or cleaning liquid, is introduced into the liquid tank 1. The liquid tank 1 is provided therein with a heater 4, a partition member 5 and an adjustment mechanism 6, such as a pump. The machining liquid 3 introduced into the liquid tank 1 is circulated in a direction shown by arrow Y1 or Y2 when the adjustment mechanism 6 has been driven with a motor (not shown) attached to the outer surface of the liquid tank 1. This circulation allows the machining liquid 3 to ascend from a passage between the bottom of the liquid tank 1 and the partition member 5 to a passage between the side of the liquid tank 1 and the partition member 5, overflow the partition member 5 and return to the bottom of the liquid tank 1. When the machining liquid 3 is solder melt, solder introduced into the liquid tank 1 is melted with the heater 4 and, when the machining liquid 3 is cleaning liquid, the cleaning liquid introduced into the liquid tank is heated as occasion demands. When the machining performed by the ultrasonic machining equipment is for cleaning, therefore, there is a case where the heater 4 is not required. The side of the liquid tank 1 is formed therein with a through-hole 7.

The resonator 8 is attached to the liquid tank 1 in the following manner. One end of the resonator 8 is passed from the exterior through the through-hole 7 and inserted into the liquid tank 1. The other end of the resonator 8 is disposed outside the liquid tank 1. A support portion 9 of the resonator 8 stops up the through-hole 7 and is fixed so as not to leak the machining liquid 3 to the outer surface of the liquid tank 1. The side surface of the resonator 8 normal to the end face of the one end of the resonator 8 is directed upward. The support portion 9 projects outward from the outer circumferential surface of the resonator 8 in which one of points of the minimum vibration amplitude exists and is formed on the resonator 8 as a projection going round the outer circumferential surface of the resonator 8. The resonator 8 is provided at least in the side surface at the one end thereof directed upward with a working vessel 10 in the form of an upward open dent capable of inserting workpiece parts 16 therein from above and accommodating therein part of the machining liquid 3 in the liquid tank 1 independently of the machining liquid 3 in the liquid tank 1. Since the working vessel 10 has a configuration in which it is formed from the side surface of the resonator 8 directed upward into the resonator 8, as described above, supersonic vibration can be well transmitted, when performing machining, such as soldering or cleaning, from the resonator 8 to the workpiece parts 16 dipped into machining liquid 13 standing still within the working vessel 10 (refer to Step 303 in FIG. 3). As a result, machining by the machining liquid 13 relative to the workpiece parts 16 is made appropriate because the wettability of solder relative to the workpiece parts 16 in the case of soldering and, in the case of cleaning, the cleaning performance (detergency) of the cleaning liquid relative to the workpiece parts 16 is made high. This is advantageous.

Since the working vessel 10 is disposed on the side surface of the resonator 8, the machining liquid 13 (refer to FIG. 3) is vibrated in the lateral direction shown by arrows X by means of the supersonic vibration from the resonator 8. A vibrator 11 is coaxially joined to the other end of the resonator with threaded rods (not shown), such as headless screws. The resonator 8 resonates with the supersonic vibration transmitted from the vibrator 11, has points of the maximum vibration amplitude on the opposite ends thereof and constitutes an ultrasonic horn having at least one point of the minimum vibration amplitude between these points of the maximum vibration amplitude and having a lateral length shown by the arrows X The vibrator 11 is an electroacoustic transducer or electrical vibration transducer, such as a piezoelectric device or magnetostrictor, for generating the supersonic vibration of a prescribed frequency by means of electric power supplied from an ultrasonic generator (not shown), outputting the same and converting electric energy into mechanical energy.

The working vessel 10 may be formed singly or, as shown in FIG. 2, plurally in one end of the resonator 8. When the width of the resonator 8 becomes large in the direction in which the plural working vessels 10 formed in the one end of the resonator as described above are arrayed, formation of slots 12 in the opposite sides of the resonator 8 with the support portion 9 as a boundary enables the vibration amplitude of the resonator 8 to be brought to a good state and allows the workpiece parts 16 to be subjected to appropriate machining. The slots 12 pass through the resonator 8 vertically. Though not shown, the working vessels 10 may be formed in the resonator 8 from the side surface thereof directed downward or from the side surfaces thereof directed upward and downward. In addition, the working vessels 10 may be formed in the other end of the resonator 8. That is to say, the number of the working vessels 10 formed in the resonator 8 may be single or plural.

Steps of machining in the ultrasonic machining equipment will be described with reference to FIG. 1 and FIG. 3. First, as shown in FIG. 1, the machining liquid 3 is introduced into the liquid tank 1. In this case, the liquid level of the working liquid 3 is set to be lower than the position of the opening of the working vessel 10. In addition, the adjustment mechanism 6 is drive at low speed so that the liquid level of the machining liquid 3 may be lower than the position of the opening of working vessel 10 when the adjustment mechanism 10 is at a stop or even when the adjustment mechanism 10 has been driven.

Next, the adjustment mechanism 6 is driven and the machining liquid 3 is circulated in the direction shown by the arrow Y1, for example. As a result, the liquid level of the machining liquid 3 around the resonator 8 ascends and is adjusted in position above the position of the opening of the working vessel 10 as shown at Step 301 in FIG. 3 to bring part of the machining liquid 3 in the working vessel 10. In the case of circulating the machining liquid 3 in the direction shown by the arrow Y2 through high-speed drive of the adjustment mechanism 6, the liquid level of the machining liquid 3 around the resonator 8 descends, whereas the liquid level of the machining liquid 3 on the left side of the partition member 5 ascends and is adjusted in position above the opening of the working vessel 10 to allow the machining liquid 3 to overflow the partition member 5 and flow around the resonator 8. Therefore, part of the machining liquid 3 is brought in the working vessel 10. Since machining liquid 13 brought in the working vessel 10 is the same as the machining liquid 3, it should be denoted by reference numeral 3. However, the machining liquid 3 in the liquid tank 1 and the machining liquid 13 in the working vessel 10 are distinguished from each other for the sake of convenience (refer to Step 302 in FIG. 3).

The adjustment mechanism 6 is then stopped or driven at low speed, so that the machining liquid 13 can remain in the working vessel 10 and the liquid level of the machining liquid 3 is adjusted in position below the position of the opening of working vessel 10. Thus, the machining liquid 13 is separated from the machining liquid 3 and is at a stop within the working vessel 10. As a result, the liquid level of the machining liquid 13 becomes stable like a mirror surface by the surface tension. Even in the case of adjusting (setting) the liquid level of the machining liquid 3 in position below the opening of the working vessel 19, since the machining liquid 3 heats the one end of the resonator 8 insofar as the one end of the resonator 8 is dipped into the machining liquid 3 as shown at Step 302 in FIG. 3, the molten state of the machining liquid 13 is appropriately retained. This is advantageous.

In the present embodiment, the liquid level of part of the machining liquid 3 introduced in the liquid tank is adjusted in position above the position of the opening of the working vessel 10 as shown at Step 301 in FIG. 3 when the adjustment mechanism 6 is drive at high speed and, when the adjustment mechanism 6 is stopped or driven at low speed, the liquid level of part of the machining liquid 3 introduced into the liquid tank 1 is adjusted in position below the opening of the working vessel 10 as shown at Step 302 in FIG. 3. Thus, the adjustment mechanism 6 constitutes a device for adjusting the liquid level of part of the machining liquid 3 introduced into the liquid tank 1 in position above and below the position of the opening of the working vessel 10.

When the vibrator 11 is continuously driven, the supersonic vibration transmitted from the resonator 8 acts on the machining liquid to be rotated in the lateral direction. Even when the machining liquid 13 is vibrated in the lateral direction, the liquid level of the machining liquid 13 is retained in a state like a mirror surface by the surface tension without heaving up the machining liquid 13. As shown at Step 303 in FIG. 3, a workpiece handling mechanism 14 supports a workpiece 15 thereon and carries it above the working vessel 10. The time the workpiece 15 is carried above the working vessel may be either prior to or subsequent to the time the vibrator 11 is driven, or the two times may be at the same time.

Furthermore, the workpiece handling mechanism 14 descends to dip the workpiece parts 16 into the machining liquid 13. As a result, the workpiece parts 16 are subjected to ultrasonic machining with the machining liquid 13 vibrated in the lateral direction by means of the supersonic vibration. That is to say, when the machining liquid 13 is solder melt, the workpiece parts 16 are soldered. When the machining liquid 3 is cleaning liquid, the workpiece parts 16 are cleaned. Since the machining liquid 13 is vibrated in the lateral direction by means of the supersonic vibration transmitted from the resonator 8, the lateral vibration acts vertically wholly on the workpiece parts 16 dipped into the machining liquid 16 to subject the workpiece parts 16 to appropriate ultrasonic machining. This is advantageous.

Moreover, since the machining liquid 13 is at a stop within the working vessel 10 without flowing out, there is an advantage that parts of the workpiece 15 other than the workpiece parts 16 neither receive thermal degradation through contact with the machining liquid 13 nor entail necessity to provide the other parts with an insulating membrane (mask membrane) relative to the machining liquid 13.

When the ultrasonic machining has been completed, the vibrator 10 ceases to drive and the workpiece parts 16 are elevated upward from the machining liquid 13 with upward movement of the workpiece handling mechanism 14. Thereafter, Steps 301 to 303 in FIG. 3 are repeated to successively subject new workpieces 15 to ultrasonic machining.

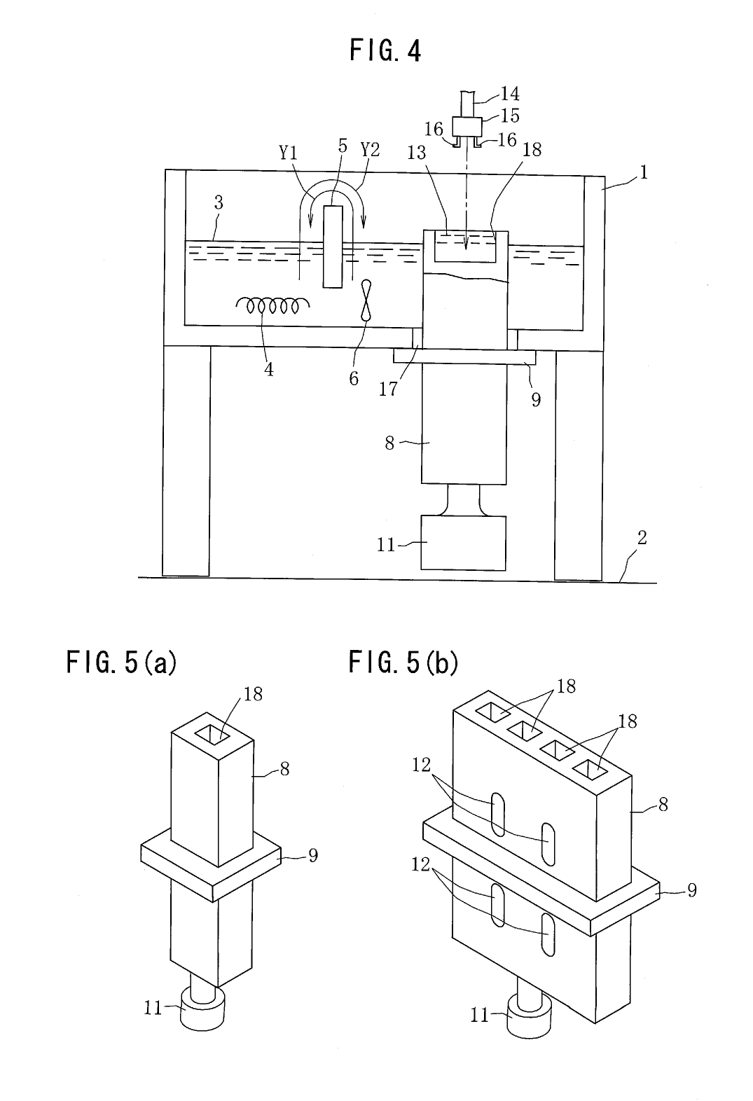

FIG. 4 and FIG. 5 show the second embodiment for carrying out the present invention, in which FIG. 4 shows ultrasonic machining equipment and FIG. 5 shows resonators 8.

As shown in FIG. 4, the second embodiment differs from the embodiment of FIG. 1 in structure of attaching the resonator 8 to a liquid tank 1, in structure of providing one end of the resonator 8 with a working vessel 18 and in direction of the supersonic vibration transmitted from the resonator 8 acting on machining liquid 13. To be specific, the liquid tank 1 is provided in the bottom thereof with a through-hole 17, one end of the resonator 8 passes through the liquid tank 1 from the exterior thereof and is inserted into the liquid tank 1, the other end of the resonator 8 is disposed outside the liquid tank 1, a support portion 9 of the resonator 8 is fixed to the liquid tank 1 so as not to permit leakage of the liquid onto the outer surface of the liquid tank 1, and the end face of the one end of the resonator 8 is directed upward. The machining liquid 13 is vertically vibrated by means of the supersonic vibration from the resonator 8.

The working vessel 18 is provided as a dent open upward and capable of accommodating part of the machining liquid 3 in the liquid tank 1 as separating from the machining liquid 3 in the liquid tank 1 so that the workpiece parts 16 may be inserted from above into the end face of the resonator 8 directed upward. Thus, since the working vessel 18 has a configuration such that it is formed from the end face of the resonator 8 directed upward in the resonator 8, it has the advantage of the machining liquid 13 transmitting the supersonic vibration from the resonator 8 appropriately to the workpiece parts 16. The steps of machining by the ultrasonic machining equipment shown in FIG. 4 will easily be understood when the working vessel 18 is substituted for the working vessel 10 shown in FIG. 3. The working vessel 18 may be formed in one end of the resonator 8 singly as shown in FIG. 5(a) or plurally as shown in FIG. 5(b). In addition, the working vessel 18 may be formed in the other end of the resonator 8. That is to say, the number of the working vessels 18 formed in the resonator 8 may be single or plural. In FIG. 5(b), slits 12 pass through the resonator 8 in the lateral direction.

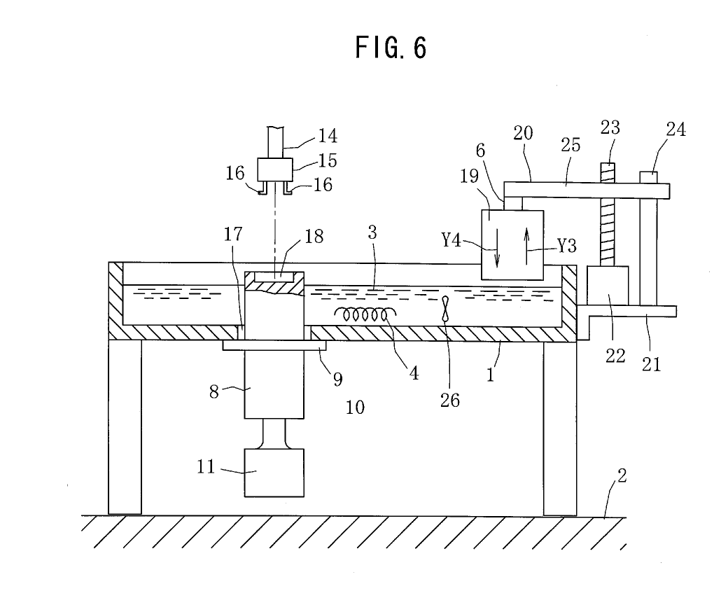

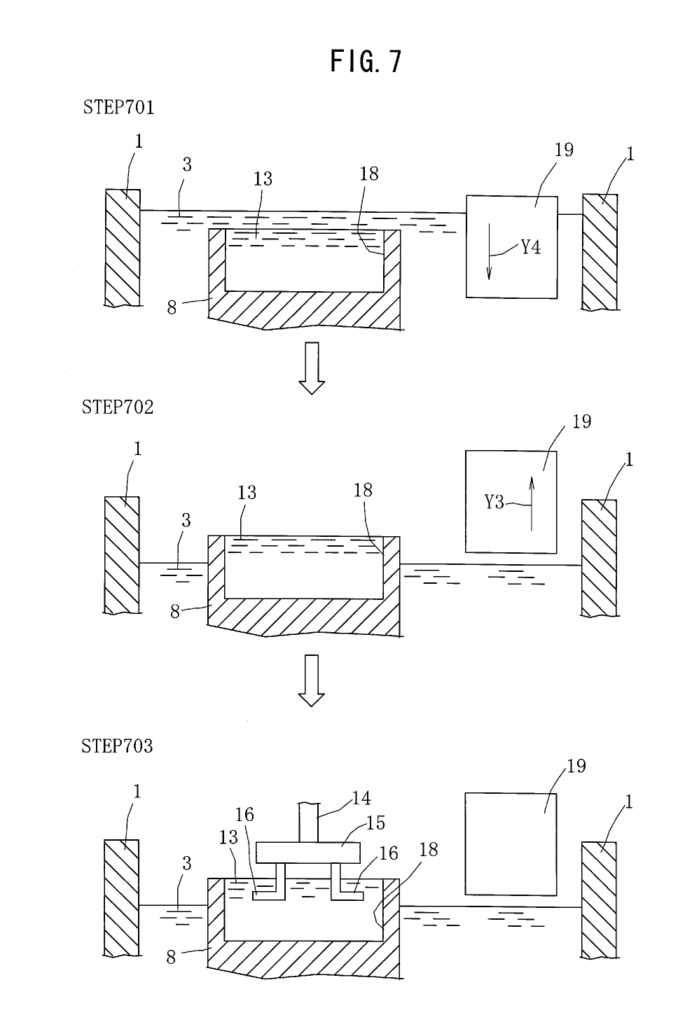

FIG. 6 and FIG. 7 show the third embodiment for carrying out the present invention, in which FIG. 6 shows ultrasonic machining equipment and FIG. 7 shows the steps of machining.

In the third embodiment, as shown in FIG. 6, an adjustment mechanism 6 differs from the adjustment mechanisms shown in FIG. 1 and FIG. 4. In the embodiment shown in FIG. 6, one end of a resonator 8 is inserted into a liquid tank 1 from a through-hole 17 formed in the bottom of the resonator 8, and a support portion 9 of the resonator 8 is fixed to the bottom of a liquid tank 1. The adjustment mechanism 6 constitutes a device for elevating and lowering a liquid level adjustment body 19 using an elevating/lowering mechanism 20. The liquid level adjustment body 19 is for adjusting the whole liquid level of machining liquid 3 in position above or below the position of the opening of a working vessel 18 depending on a variation in volume thereof inserted into the machining liquid 3.

The elevating/lowering mechanism 20 comprises a fixed base 21, a motor 22, a threaded rod 23, a guide mast 24 and an elevating/lowering member 25. The fixed base 21 is fixed to the outer side surface of the liquid tank 1. The motor 22 and guide mast 24 are fixed to the fixed base 21. The threaded rod 23 is joined to an output shaft, such as a motor shaft, projecting upward from the motor 22. The elevating/lowering member 25 is fitted in the threaded rod 23 and guide mast 24. The elevating/lowering member 25 ascends linearly in the direction shown by arrow Y3 while being guided with the guide mast 24, followed by rotation of the threaded rod 23 in one direction driven by the motor 22. The elevating/lowering member 25 descends linearly in the direction shown by arrow Y4 while being guided with the guide mast 24, followed by rotation of the threaded rod 23 in the other direction driven by the motor 22. That is to say, the elevating/lowering member 25 is elevated and lowered by driving the motor 22. A liquid level adjustment body 19 is fixed to the end of the elevating/lowering member 25 extending above the liquid tank 1. Therefore, with the ascent or descent of the elevating/lowering member 25 the liquid level adjustment body 19 is elevated or lowered. In addition, the liquid tank 1 is provided therein with a stirring mechanism 26, such as a pump, which stirs the machining liquid 3 to generate a convection flow in the machining liquid 3, thereby retaining good molten state of the machining liquid 3.

Steps of machining in the ultrasonic machining equipment will be described with reference to FIG. 6 and FIG. 7. First, as shown in FIG. 6, the machining liquid 3 is introduced into the liquid tank 1 so that the liquid level of the working liquid 3 may be set to be lower than the position of the opening of the working vessel 18. It is noted that the elevating/lowering 25 is stopped at a limit position of ascent as shown in FIG. 6 and that the liquid level adjustment body 19 is disposed above the liquid level of the machining liquid 3. Next, with the descent of the elevating/lowering member 25, the liquid level adjustment body 19 enters the machining liquid 3 within the liquid tank 1 from the liquid level thereof and, in accordance with the volume of the liquid level adjustment body 19 entering the machining liquid 3, the liquid level of the machining liquid 3 ascends and is adjusted in position above the opening of the working vessel 18 as shown at Step 701 in FIG. 7.

When the liquid level of the machining liquid 3 is adjusted in position above the position of the opening of the working vessel 18 as shown at Step 701 in FIG. 7, part of the machining liquid 3 is taken in the working vessel 18 from the liquid tank 1 as machining liquid 13 and then the elevating/lowering member 25 ascends. With this ascent, as shown at Step 702 in FIG. 7, the liquid level adjustment body 19 moves upward from the liquid level of the machining liquid 3, the liquid level of the machining liquid 3 is adjusted in position below the position of the opening of the working vessel 18, with the machining liquid 13 remaining in the working vessel 18, and the machining liquid 13 is at a stop within the working vessel 18 as separating from the machining liquid 3.

A vibrator 11 shown in FIG. 6 is thereafter driven and, as shown at Step 703 in FIG. 7, workpiece parts 16 are dipped in the machining liquid 13 vibrated vertically with supersonic vibration to be subjected to ultrasonic machining. Upon completion of the ultrasonic machining, the vibrator 11 ceases to drive and the workpiece parts 16 are elevated upward from the machining liquid 13. Thereafter, Steps 701 to 703 are repeated to successively subject new workpieces 15 to ultrasonic machining.

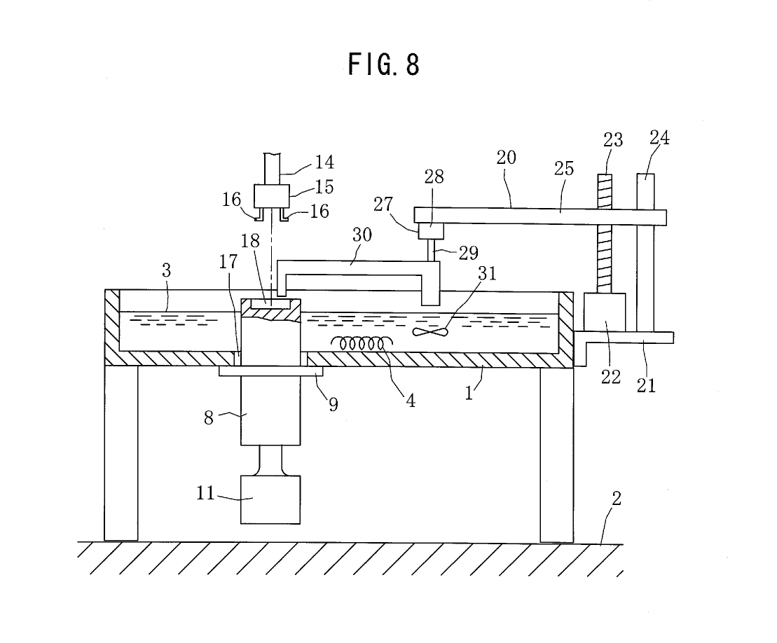

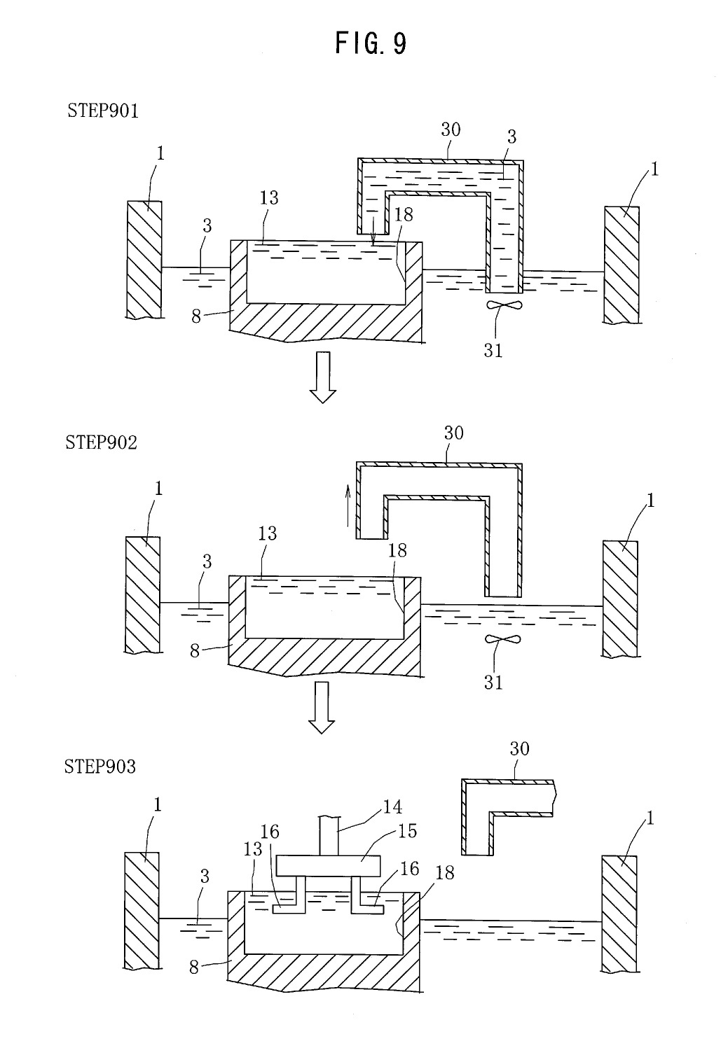

FIG. 8 and FIG. 9 show the fourth embodiment for carrying out the present invention, in which FIG. 8 shows ultrasonic machining equipment and FIG. 9 shows steps of machining.

The fourth embodiment differs from the embodiments shown in FIG. 1, FIG. 4 and FIG. 6, respectively, in that as shown in FIG. 8, a liquid tank 1 is provided with a supply mechanism 27 in place of the adjustment mechanisms 6 shown in FIG. 1, FIG. 4 and FIG. 6. The supply mechanism 27 comprises an elevating/lowering mechanism 20, a rotation mechanism 28 including a motor, a pipe 30 fixed to an output shaft 29 of the rotation mechanism 28 and a jet flow mechanism 31 disposed inside the liquid tank 1. One end of the pipe 30 constitutes an inlet for taking machining liquid 3 in the pipe 30. The other end of the pipe 30 constitutes an outlet for discharging the machining liquid 3 from the pipe 30. The inlet of the pipe 30 is always directed toward a jet flow so that part of the machining liquid 3 ascending by means of the jet flow mechanism 31 may be taken therein even when the pipe 30 is rotated with the rotation mechanism 28. When the pipe 30 has been rotated in one direction with the rotation mechanism 28 and stopped, the outlet of the pipe 30 departs sideways from the upper side of a working vessel 18 and faces the upper side of the liquid tank 1. When the pipe 30 has been rotated in the other direction with the rotation mechanism 28 and stopped, the outlet of the pipe 30 departs sideways from the upper side of the liquid tank 1 and faces the upper side of the working vessel 18.

Steps of machining by the ultrasonic machining equipment will be described with reference to FIG. 8 and FIG. 9. First, as shown in FIG. 8, the machining liquid 3 is inserted into the liquid tank 1 so that the liquid level of the machining liquid 3 may be set to be lower than the position of the opening of the working vessel 18. It is noted that an elevating/lowering member 25 is stopped at a limit position of ascent as shown in FIG. 8, that the inlet of the pipe 30 is separated upward from the liquid level of the machining liquid 3 so as not to take the machining liquid 3 in the inlet of the pipe 30 and faces the opening of the working vessel 18 and that the jet flow mechanism 31 is driven.

The pipe 30 is lowered with the elevating/lowering mechanism 20 of FIG. 8 to cause the outlet of the pipe 30 to approach the opening of the working vessel and, with the inlet of the pipe entering the machining liquid 3, part of the machining liquid 3 is taken in the inlet of the pipe 30. The machining liquid 3 taken in the inlet is taken as machining liquid 13 in the working vessel 18 from the outlet of the pipe 30 as shown at Step 901 in FIG. 9. The pipe 30 is then elevated with the elevating/lowering mechanism 20 of FIG. 8 as shown at step 902 in FIG. 9 and, when the inlet of the pipe 30 has departed upward from the liquid level of the machining liquid 3, the machining liquid 3 cannot enter the inlet of the pipe 30 to stop the supply of the machining liquid 3 from the outlet of the pipe 30 to the working vessel 18 (refer to Step 902 in FIG. 9). With this, the machining liquid 13 departs from the machining liquid 3 to be at a stop within the working vessel 18.

The rotation mechanism 28 of FIG. 8 is then rotated to move the outlet of the pipe 30 from the working vessel 18 to the liquid tank 1. As shown at Step 903 in FIG. 9, thereafter, the workpiece handling mechanism 14 carries the workpiece 15 to the upper side of the working vessel 18, and the vibrator 11 of FIG. 8 is driven to lower the workpiece handling mechanism 14, thereby dipping the workpiece parts 16 into the machining liquid 13. In this case, since the pipe 30 moves sideways from the working vessel 18, even when the working vessel 18 has been formed to be as small as possible within a range in which the workpiece parts 16 can be inserted in a non-contact state into the working vessel 18, the workpiece parts 16 can appropriately be inserted into the working vessel 18 without avoiding the pipe 30. This is advantageous. In consequence of the workpiece parts 16 having been inserted into the working vessel 16, the workpiece parts 16 receive supersonic vibration from the resonator 8 and are subjected to ultrasonic machining. Upon completion of the ultrasonic machining, the vibrator 11 ceases to drive and the workpiece parts 16 are taken out of the machining liquid 13. Thereafter, Steps 901 to 903 in FIG. 9 are repeated to successively subject new workpieces 15 to ultrasonic machining.

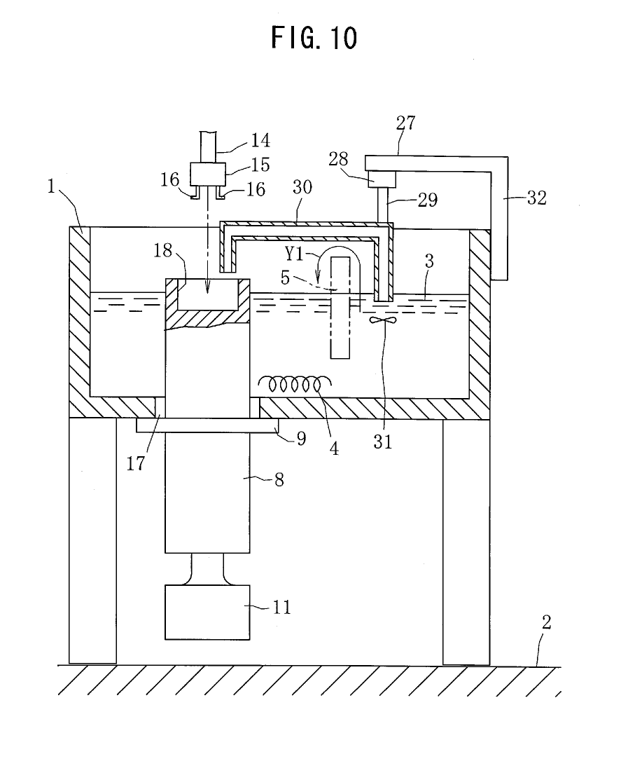

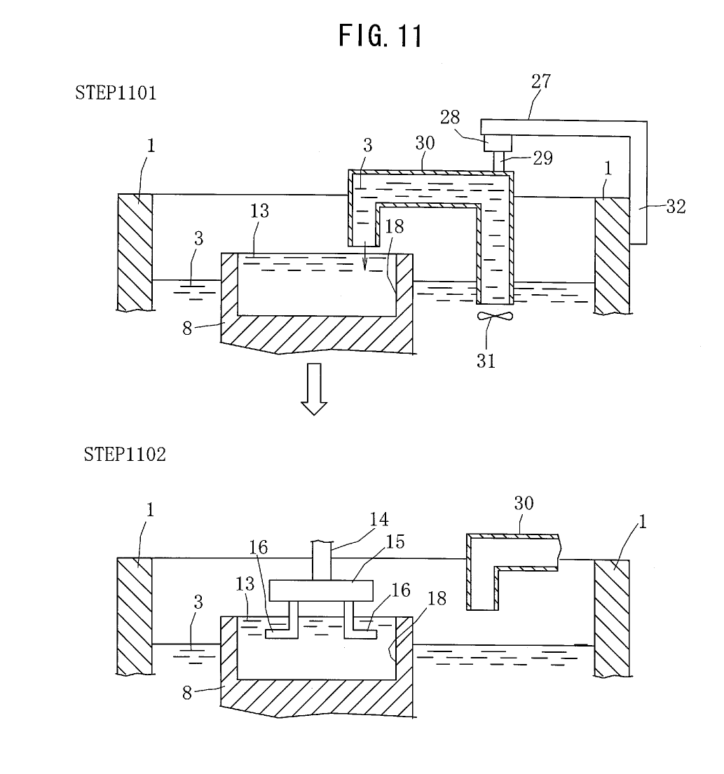

FIG. 10 and FIG. 11 show the fifth embodiment for carrying out the present invention, in which FIG. 10 shows ultrasonic machining equipment and FIG. 11 shows steps of machining. In the fifth embodiment, as shown in FIG. 10, a supply mechanism 27 differs in structure from that of the embodiment shown in FIG. 8. To be specific, it comprises a support post 32 fixed to a liquid tank 1 and a rotation mechanism 28 formed on the support post 32. It is noted that machining liquid 3 is introduced into the liquid tank 1 so that the liquid level of the machining liquid 3 may be set to be lower than the position of the opening of a working vessel 18, that an inlet of a pipe 30 is disposed on the side of the machining liquid 3, that an outlet of the pipe 30 departs from the upper side of the opening of the working vessel 18 to face the opening of the working vessel 18 and that a jet flow mechanism 31 is driven.

According to the ultrasonic machining equipment of the fifth embodiment, as shown at Step 1101 in FIG. 11, part of the machining liquid 3 goes through the pipe 30 and is taken as machining liquid 13 in the working vessel 18, followed by driving of the jet flow mechanism 31. Next, after the machining liquid 13 overflows the working vessel 18, the rotation mechanism 28 is rotated to move the outlet of the pipe 30 from the working vessel 18 toward the liquid tank 1 as shown at Step 1102 in FIG. 11. As a result, the supply of the machining liquid 3 to the working vessel 18 is stopped to allow the machining liquid 13 to depart from the machining liquid 3 and to be at a stop within the working vessel 18.

A vibrator 11 of FIG. 10 is then driven and, as shown at Step 1102 in FIG. 11, the workpiece parts 16 are dipped into the machining liquid 13 vertically vibrated with supersonic vibration transmitted from a resonator 8 and is subjected to ultrasonic machining. Upon completion of the ultrasonic machining, the vibrator 11 ceases to drive and the workpiece parts 16 are to taken out of the machining liquid 13. Thereafter, the rotation mechanism 28 is rotated to move the outlet of the pipe 30 from the liquid tank 1 to the working vessel 18 and face the opening of the working vessel 18. Steps 1101 and 1102 in FIG. 11 are repeated to successively subject new workpieces 15 to ultrasonic machining.

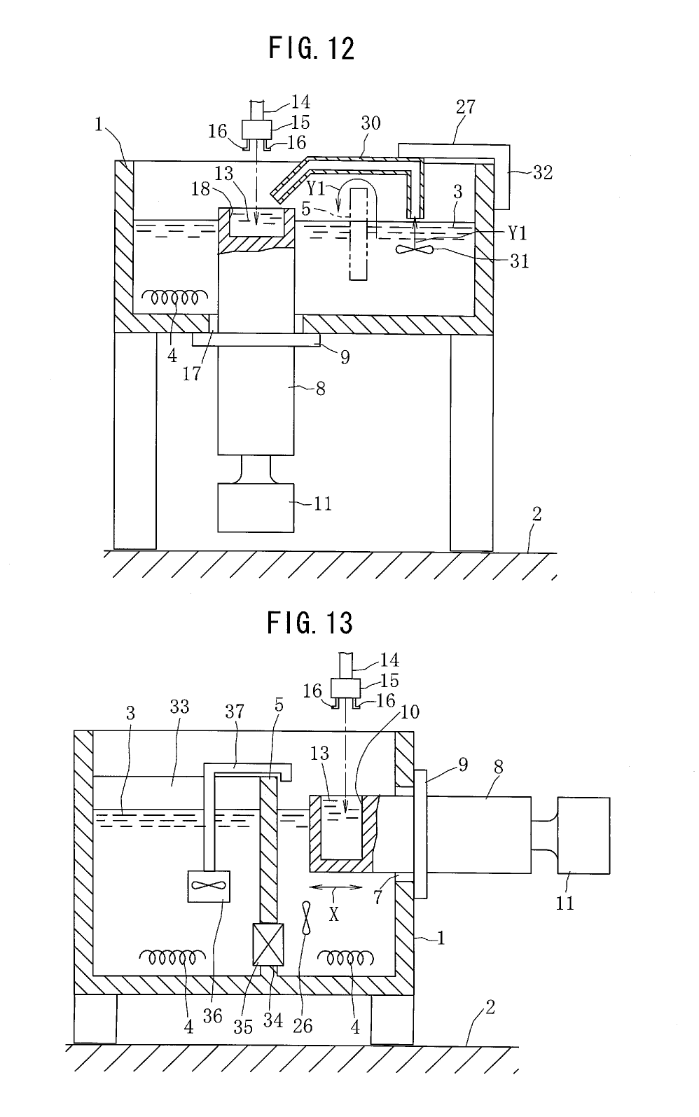

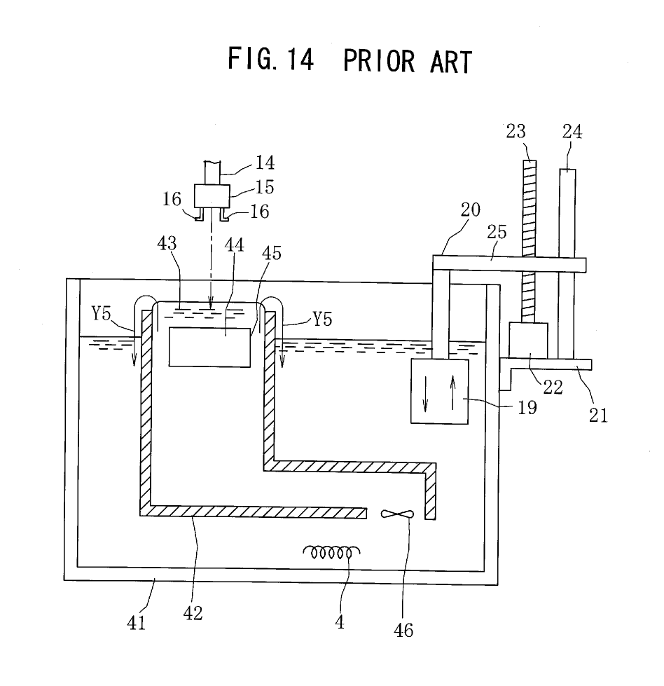

FIG. 12 shows ultrasonic machining equipment according to the sixth embodiment for carrying out the present invention. In the sixth embodiment, as shown in FIG. 12, a supply mechanism 27 differs in structure from that of each of the embodiments shown in FIG. 8 and FIG. 10. To be specific, a pipe 30 is fixed to a support post 32, the inlet of the pipe 30 is disposed on the side of a machining liquid 3, and the outlet of the pipe 30 departs upward from the opening of a working vessel 18 and faces the opening the working vessel. Therefore, the sixth embodiment has simple structure, in which a supply mechanism 27 is not provided with either the elevating/lowering mechanism shown in FIG. 6 or FIG. 8 or the rotation mechanism 28 shown in FIG. 10.

According to the ultrasonic machining equipment of the sixth embodiment, when a jet flow mechanism 31 is driven at high speed, part of machining liquid 3 is elevated and taken in the inlet of the pipe 30 and the machining liquid 3 taken in the inlet is taken from the outlet of the pipe 30 in the working vessel 18 as machining liquid 13. When the machining liquid 13 overflows the working vessel 18, the jet flow mechanism 31 is stopped or driven at low speed so as not to take the machining liquid 3 in the inlet of the pipe 30 even when the jet flow mechanism 31 is driven. As a consequence of stopping or driving at low speed the jet flow mechanism 31, the supply of the machining liquid 3 to the working vessel 18 is stopped, and the machining liquid 13 departs from the machining liquid 3 and is at a stop within the working vessel 18.

Thereafter, a vibrator 11 is driven to dip workpiece parts 16 into the machining liquid vertically vibrated with supersonic vibration transmitted from a resonator 8 and subjected to ultrasonic machining. Upon completion of the ultrasonic machining, the vibration ceases to drive and the workpiece parts 16 are taken out of the machining liquid 13. The steps of driving the jet flow mechanism 31 at high speed, stopping or driving at low speed the jet flow mechanism 31, dipping the workpiece parts 16 into the machining liquid 13 and taking the workpiece parts 16 out of the machining liquid 13 are repeated to successively subject new workpieces 15 to ultrasonic machining.

FIG. 13 shows ultrasonic machining equipment according to the seventh embodiment for carrying out the present invention. As shown in FIG. 13, the seventh embodiment differs in structure from the embodiments shown in FIGS. 1, 4, 6, 8 and 10, respectively, in that a liquid tank 1 is provided therein with a tank 33, that a passage 34 for machining liquid 3 from the liquid tank 1 to the tank 33 is provided therein with a valve and that the tank 33 is equipped with a pump 36. The tank 33 is for storing the machining liquid so as to adjust the liquid level of the machining liquid 3 in position to be lower than the opening of a working vessel 10. The valve 35 is for opening/closing the passage 34. The pump 36 is for return the machining liquid 3 from the tank 33 to the liquid tank 1 so as to adjust the liquid level of the machining liquid 3 in position to be higher than the opening of the working vessel. An outlet pipe 37 of the pump 36 is disposed on the upper side of the liquid tank 1 over the tank 33.

According to the ultrasonic machining equipment shown in FIG. 13, the machining liquid 3 is inserted into the liquid tank 1 so that the liquid level of the machining liquid 3 may be set to be lower than the opening of the working vessel 10. In this case, it is noted that the valve 35 is open and that the pump 26 is stopped. Therefore, the liquid tank 1 and tank 33 are filled with the machining liquid 3 inserted into the liquid tank 1. The valve 35 is closed and the pump 36 is driven to allow the machining liquid 3 to go through the outlet pipe 37 from the tank 33 and return to the liquid tank. to As a result, the machining liquid 3 in the liquid tank 1 is adjusted in position to be higher than the position of the opening of the working vessel 10. With this, part of the machining liquid 3 in the liquid tank 1 is taken as machining liquid 13 in the working vessel 10. Thereafter, when the valve has been opened and the pump 36 has been at a stop, the liquid level of the machining liquid 3 in the liquid tank 1 is adjusted in position to be lower than the position of the opening of the working vessel 10. In addition, the machining liquid 13 is separated from the machining liquid 3 to be at a stop within the working vessel 10.

Thereafter, the vibrator 11 is driven to dip the workpiece parts 16 into the machining liquid 13 vertically vibrated with supersonic vibration transmitted from the resonator and subject the workpiece parts 16 to ultrasonic machining. Upon completion of the ultrasonic machining, the vibrator 11 ceases to drive and consequently the workpiece parts 16 are taken out of the machining liquid 13. Then, the steps of opening/closing the valve 35, driving/stopping the pump 36, dipping the workpiece parts 16 into the machining liquid 13 and elevating the workpiece parts 16 from the machining liquid 13 are repeated to successively subject new workpieces 15 to ultrasonic machining.

Though not shown in FIGS. 6, 8, 10 and 12, the resonator 8 provided with the working vessel 10 as shown in FIG. 1 may be used in place of the resonator 8 provided with the working vessel 18. In this case, the step of soldering or cleaning by the ultrasonic machining equipment can easily be understood by substituting the working vessel 10 for the working vessel 18 in FIG. 7, 9 or 11. Though not shown in FIG. 13, the resonator 8 provided with the working vessel 18 shown in FIG. 4 may be used in place of the resonator 8 provided with the working vessel 10. In this case, the step of soldering or cleaning can easily be understood by substituting the working vessel 18 for the working vessel 10.

In FIG. 6 and FIG. 8, the elevating/lowering member 25 may be elevated or lowered with a cylinder or human power in place of the motor 22.

In FIG. 6, when the elevating/lowering member 25 has been stopped at a limit position of ascent, the lower end of the liquid level adjustment body 19 may be dipped into the machining liquid 3. That is to say, even when the elevating/lowering member 25 is elevated or lowered between the limit position of ascent and the limit position of descent, the liquid level adjustment body 19 may have a configuration in which the lower end thereof does not project upward from the machining liquid 3. A configuration may be adopted, in which the lower end or lateral side of the liquid tank 1 around the portion to which the resonator 8 is attached projects downward from the lower end of the liquid tank 1 at the portion to which the resonator 8 is attached to increase the volume of the liquid tank 1.

Though not shown in FIG. 1 or FIG. 4, the liquid tank 1 may be provided with a device for elevating/lowering the liquid level adjustment body 19 shown in FIG. 6 with the elevating/lowering mechanism 20 to reduce the amount of the machining liquid 3 in accordance with the progress of the ultrasonic machining by the ultrasonic machining equipment and, in the case where the liquid level of the machining liquid 3 has been lowered more than usually to the lower side of the opening of the working vessel 10 or 18, the volume of the liquid level adjustment body 19 entering the machining liquid 3 may be increased to adjust the height of the liquid level of the machining liquid 3 below the opening of the working vessel 10 or 18 to be at an appropriate position.

As shown by an imaginary line in FIG. 10 and FIG. 12, a partition member 5 may be provided within the liquid tank 1 to circulate part of the machining liquid 3 in the direction sown by arrow Y1 through high-speed driving of the jet flow mechanism 31.

In FIG. 1, 4, 6, 8, 10, 12 or 13, a booster (not shown) may be coaxially joined to the resonator 8 with a threaded rod, such as a headless screw (not shown) for varying a magnification ratio of the vibration amplitude. By so doing, the booster may be disposed singly or plurally between the resonator 8 and the vibrator 11, thereby extending the distance between the resonator 8 and the vibrator 11 so as not transmit the heat of the machining liquid 3 or 13 from the resonator 8 to the vibrator 11. The booster has a length of the integral multiple of ½ of the resonance frequency. The points of maximum vibration amplitude are disposed on the opposite sides of the booster. In addition, the booster may be cooled through blow of air onto it with a fan.

What is claimed is:

1. A resonator used for ultrasonic machining and attached to a side or bottom of a liquid tank so as to pass through the liquid tank used in ultrasonic machining equipment for dipping a workpiece part in machining liquid given supersonic vibration, said resonator comprising a working vessel formed in one end of the resonator within the liquid tank as a dent opening upward so as to enable the workpiece part to be inserted therein from above and part of the machining liquid in the liquid tank to be accommodated therein as separated from the machining liquid in the liquid tank.

2. Ultrasonic machining equipment comprising:
a liquid tank;
a resonator attached to a side or bottom of the liquid tank so as to pass through the liquid tank;
a vibrator joined to one end of the resonator outside the liquid tank;
a working vessel formed in the other end of the resonator inside the liquid tank as a dent so as to enable a workpiece part to be inserted therein from above and part of machining liquid introduced into the liquid tank to be accommodated therein as separated from the machining liquid; and
a liquid level adjustment mechanism provided within the liquid tank for adjusting a liquid level introduced into the liquid tank to be higher and lower than an opening of the working vessel.

3. a liquid tank;
a resonator attached to a side or bottom of the liquid tank so as to pass through the liquid tank;
a vibrator joined to one end of the resonator outside the liquid tank;
a working vessel formed in the other end of the resonator inside the liquid tank as a dent so as to enable a workpiece part to be inserted therein from above and part of machining liquid introduced into the liquid tank to be accommodated therein as separated from the machining liquid; and
a supply mechanism provided within the liquid tank for supplying the machining liquid in the liquid tank into the working vessel.

4. Ultrasonic machining equipment comprising:
a liquid tank;
a resonator attached to a side or bottom of the liquid tank so as to pass through the liquid tank;
a vibrator joined to one end of the resonator outside the liquid tank;
a working vessel formed in the other end of the resonator inside the liquid tank as a dent so as to enable a workpiece part to be inserted therein from above and part of machining liquid introduced into the liquid tank to be accommodated therein as separated from the machining liquid;
a tank for storing the machining liquid in the liquid tank so as to adjust a liquid level of the machining liquid in the liquid tank to be lower than an opening of the working vessel;
a valve for opening/closing a passage for the machining liquid from the liquid tank to the tank; and
a pump for returning the machining liquid from the tank to the liquid tank so as to adjust the liquid level of the machining liquid in the liquid tank to be higher than the opening of the working vessel.
